(19) United States
(12) Patent Application Publication
(10) Pub. No.: US 2014/0278345 A1
(43) Pub. Date: Sep. 18, 2014

(54) MEDICAL TRANSLATOR

(71) Applicant: Michael Koski, Carbondale, CO (US)

(72) Inventor: Michael Koski, Carbondale, CO (US)

(21) Appl. No.: 14/203,291

(22) Filed: Mar. 10, 2014

Related U.S. Application Data
(60) Provisional application No. 61/784,967, filed on Mar. 14, 2013.

(51) Int. Cl. G06F 17/28

(52) U.S. Cl. CPC G06F 17/28
USPC 704/2

(57) ABSTRACT

An example medical translator system may include a language selector configured to offer a plurality of selectable language options and receive a language option selection. The medical translator system may also include a path selector configured to offer a user a plurality of selectable interactive paths in accordance with the language option selection. The medical translator system may also include an interactive guide configured to render a plurality of medical care questions and/or medical care directions for the user in the language option selection and in accordance with the a selected interactive path. The medical translator system may also include a patient data module configured to receive patient medical information from the user and transmit the patient medical information to a medical provider in accordance with the choice of interactive path.

### PRIORITY CLAIM

This application claims the benefit of U.S. Provisional Patent Application No. 61/784,967 filed on Mar. 14, 2013 and titled “Medical Translator” of Michael Koski, and is hereby incorporated by reference in its entirety as though fully set forth herein.

### BACKGROUND

Medical patients often need to communicate basic information to care providers such as emergency medical technicians (EMTs), emergency room personnel, and others. This basic information including, for example, patient name, patient date of birth, patient insurance information, and ailments may not be readily apparent to the care providers. In some instances, a patient may not be able to communicate with medical care providers for one reason or another. For example, the patient is deaf or does not speak the same language as any of the medical personnel. Although most major hospitals employ a translator, waiting for a translator to become available before collecting medical information from the patient can delay treatment and increase patient frustration.

### BRIEF DESCRIPTION OF THE DRAWINGS

FIG. 1 is a high-level illustration of an example networked computer system in which the medical translator may be implemented.

FIG. 2 is a high-level illustration of an example client-side device of the medical translator.

FIG. 3 is an example patient interface of the medical translator.

FIG. 4 is a flowchart illustrating example operations which may be implemented by the medical translator.

FIG. 5 shows an interface of the medical translator illustrating an example “check in” interactive path.

FIG. 6 shows an interface of the medical translator illustrating an example “action” interactive path.

FIG. 7 is another flowchart illustrating example operations which may be implemented by the medical translator.

FIG. 8 shows an interface of the medical translator illustrating an example question reconfiguration interface.

FIG. 9 is shows an interface of the medical translator illustrating an example of language acquisition.

### DETAILED DESCRIPTION

A medical translator may be used to speed-up health care and improve the comfort and satisfaction of patients not speaking the same language or otherwise inhibited from communicating with medical care personnel or staff (e.g., first responders, or those at a medical facility). In an example, a medical translator may be customized for each facility, departments within the facility, and/or other uses (e.g., in the field by EMTs).

It should be noted that the medical translator is not intended to be a medical diagnostics tool. Instead, the medical translator may assist or facilitate first responders in communicating basic patient information to a medical care facility before and/or during transport; and/or as part of a check-in process at the medical care facility.

In an example, the medical translator may include a computer program product embodied as computer-readable instructions stored on non-transient computer-readable media, and the instructions are executable by a processor to offer a plurality of selectable language options, receive a language option selection, present a plurality of selectable interactive paths in accordance with the language option selection, accept a choice of interactive path, and output a plurality of medical care questions or directions in accordance with the language option selection and the choice of interactive path.

In another example, a computer-implemented method includes operations of offering a plurality of selectable language options, receiving a language option selection from a user, and presenting a plurality of selectable interactive paths for the user, in accordance with the language option selection. Further operations may include receiving a choice of interactive path, outputting a plurality of medical care questions and/or directions for the user in accordance with the language option selection and/or the choice of interactive path, receiving patient medical information in accordance with the choice of interactive path, and transmitting the patient medical information to a medical provider.

In another example, a medical translator system may include a language selector, a path selector, an interactive guide, and a patient data module. The language selector is configured to offer a plurality of selectable language options to the output and to receive a language option selection. The path selector is configured to present a plurality of selectable interactive paths to the output in accordance with the language option selection, and to accept a choice of interactive path. The interactive guide is configured to render a plurality of medical care questions or directions to the output in accordance with the language option selection and/or the choice of interactive path. The patient data module is configured to receive patient medical information in accordance with the choice of interactive path.

Before continuing, it is noted that as used herein, the terms “includes” and “including” mean, but is not limited to, “includes” or “including” and “includes at least” or “including at least.” The term “based on” means “based on” and “based at least in part on.”

FIG. 1 is a high-level illustration of an example networked computer system in which the medical translator may be implemented. System 100 may be implemented with any of a wide variety of computing devices, such as, but not limited to, stand-alone desktop/laptop/netbook computers, workstations, server computers, mobile devices, and appliances (e.g., devices dedicated to providing a service), to name only a few examples. Each of the computing devices may include memory, storage, and a degree of data processing capability at least sufficient to manage a communications connection either directly with one another or indirectly (e.g., via a network). At least one of the computing devices is also configured with sufficient processing capability to execute program code described herein.

In an example, system 100 may include a host 110 providing a medical translator service 105 accessed by a user 101 via a client device 120. For purposes of illustration, medical translator service 105 may be an online data processing service executing on a host 110 configured as a server computer with computer-readable storage 115. The medical translator service 105 by implemented by interfaces to application programming interfaces (APIs) and related support infrastructure.

The client 120 may be any suitable computer or computing device 120a-c capable of accessing the host 110. Host 110 and client 120 are not limited to any particular type of devices or systems. Although, it is noted that the operations described herein may be executed by program code residing on the client (e.g., personal computer 120a), in some instances (e.g., where the client is a tablet 120b or mobile device 120c) operations may be better performed on a separate computer system having more processing capability, such as a server computer or plurality of server computers on a local area network for the client 120. In an example, a medical translator as disclosed may in part be implemented as a mobile application or “app” for use on mobile devices (e.g., a phone or tablet device), although other implementations are also contemplated (e.g., a handheld or other computing device).

System 100 may also include a communication network 130, such as a local area network (LAN) and/or wide area network (WAN). In one example, network 130 includes the Internet or other mobile communications network (e.g., a 3G or 4G mobile device network).

The medical translator service 105 may include access to at least one source 115 of content, and/or the medical translator service 105 may be operable to communicate with at least one remote source 140 of content. That is, the source may be part of service 105, and/or the source may be physically distributed in the network and operatively associated with service 105. In any implementation, the source may include content to facilitate communication between a patient a medical provider. For example, source 140 may include databases for providing information, applications for providing application data, storage resources for providing online storage facilities.

Before continuing, it should be noted that the examples described above are provided for purposes of illustration, and are not intended to be limiting. Other devices and/or device configurations may be utilized to carry out the operations described herein.

In an example use case, a user of medical translator 280 may be a patient who enters medical facility. The patient may not speak the language commonly known at the facility or may have other issues inhibiting or preventing communication with facility staff. When a translator is not immediately available, a medical caregiver or other facility staff member directs the patient to a client device operatively associated with the medical translator application.

The patient, who speaks Spanish, is able to view options on the home page for the Spanish language and makes an appropriate selection. The medical translator may display text and/or video and/or audio instructions for the patient in the Spanish language and requests information. For example, the medical translator may ask the patient informational questions in Spanish audio and/or video, and/or present informational questions in Spanish text, and/or present icons to the user. The medical translator may also collect user input via audio recording, icon selection, and/or text input by the user. In an example, the medical translator may include a translation module so that input by the user (e.g., spoke or typed) is translated into the language common to the facility. The medical translator may ask further questions of the user based on input, and/or present the user with options and/or instructions for proceeding. The medical translator may also generate a report and transmit the report to the front desk, a nurse station, and/or generate a patient record.

As noted above, the medical translator may be implemented by machine readable instructions installed at memory of client device, at host or a combination of these and are executable for facilitating medical care. In an example, the program code may be implemented in machine-readable instructions (such as but not limited to, software or firmware). The machine-readable instructions may be stored on a non-transient computer readable medium and are executable by one or more processors to perform the operations described herein including actions or steps referred to in FIGS. 4 and 7. It is noted, however, that the components shown in FIG. 2 are provided only for purposes of illustration of an example operating environment, and are not intended to limit implementation to any particular system.

The machine readable instructions are executable to offer a plurality of selectable language options; receive a language option selection; present a plurality of selectable interactive paths in accordance with the language option selection; accept a choice of interactive path; and output a plurality of medical care questions or directions in accordance with the language option selection and the choice of interactive path. The computer-readable instructions are additionally executable to receive patient medical information in accordance with a “check-in” interactive path; to receive patient emergency medical information in accordance with a “triage” interactive path and to output one or more medical directions in accordance with an “action” interactive path.

When executed on a processor, the logic instructions cause a general purpose computing device to be programmed as a special-purpose machine that implements the described operations. In an example, the components and connections depicted in the figures may be used. Program code used to implement features of medical translator 280 and associated computer-implemented methods can be better understood with reference to FIG. 2 and the following discussion of various example computer-executable instructions. However, the operations described herein are not limited to any specific implementation with any particular type of program code.

FIG. 2 is a high-level illustration of an example client-side device 210 of the medical translator. In an example, the client-side device 210 may be implemented as one or more of the client devices 120 shown in FIG. 1. Client-side device 210 may include, but is not limited to, memory 220, processor 260, Input/Output (I/O) devices 240, a network or other communications interface 270, sensors 250, and a system bus 230 that operatively couples various of the components above-referenced components.

I/O devices 240 may include, but are not limited to, a display for presenting graphical images to a user of client device 210. In an example, the display may be a touch-sensitive screen operable to receive tactile inputs from the user. These tactile inputs may, for example, include clicking, tapping, pointing, moving, pressing and/or swiping with a finger or a touch-sensitive object like a pen.

Additionally or alternatively, I/O devices 240 include a mouse operable to receive inputs corresponding to clicking, pointing, and/or moving a pointer object on the graphical user interface. I/O devices 240 may also include a keyboard operable to receive inputs corresponding to pushing certain buttons on the keyboard.

Additionally, I/O devices 240 may also include a microphone for receiving an audio input from the user, and a speaker for providing an audio output to the user.

Memory 220 optionally includes non-removable memory, removable memory, or a combination thereof. The non-removable memory, for example, includes Random-Access Memory (RAM), Read-Only Memory (ROM), flash memory, or a hard drive. The removable memory, for example, includes flash memory cards, memory sticks, or smart cards.

Memory 220 may be operable to store a language selector 281, a path selector 283, an interactive guide 285, a patient data module 287, and/or an imaging component 288. Language selector 281, path selector 283, interactive guide 285, patient data module 287, and imaging component 288 may be, for example, modules of a medical translator software product 280 associated with a medical care translation and facilitation service provided by server 110. Executing medical translator 280 on processor 260 results in generating and rendering a graphical user interface on a display screen (see, e.g., FIGS. 3, 5, 6, 8 & 9). The graphical user interface may be configured to facilitate user interactions with a medical facilitation service by providing medical translation.

Language selector 281 is arranged to offer a plurality of selectable language options and to receive a language option selection (e.g., via I/O devices 240). Path selector 283 is configured to present a plurality of selectable interactive paths (e.g., via I/O devices 240) in accordance with the language option selection and to accept a choice of interactive path.

Interactive guide 285 is configured to render a plurality of medical care questions or directions to I/O devices 240 in accordance with the language option selection and the choice of interactive path. Interactive guide 285 may be further configured to output media associated with the plurality of medical care questions or directions. Media output by interactive guide 285 may include but is not limited to video footage communicating the plurality of medical care questions or directions in accordance with the language option selection.

By way of illustration, an example interactive path is a Nurse to Patient communication path. For example, a non-English speaking patient is in the hospital for a week, and on a regular basis the nurse needs to communicate with the patient such as “we need to draw blood”, “we are going to x-ray”, “please take this medication”, “how are you feeling?” “what is your pain level?”, etc. These questions can be pre-loaded into the interactive guide 285 for presentation to the patient. The patient can respond, as appropriate from a selection of answers which are presented to the patient.

Patient data module 287 is arranged to receive patient medical information in accordance with interactive paths. For purposes of illustration, interactive paths may include but are not limited to “check in” and/or “triage” interactive paths.

Patient medical information or data may be transmitted (e.g., to a medical provider) using network interface or transceiver 270. In an example, transmission of patient medical information may be by packaging the information in comma separated variable format, or other suitable format. For example, patient medical information may be sent as electronic mail and/or as an attachment to an electronic mail message. Other transmission means are also contemplated.

An imaging component 289 (e.g., digital camera or scanner) may be arranged to capture image data and automatically associate the image data with patient medical information.

Other modules (not shown) are also contemplated as being within the scope of the disclosure herein. By way of example, a privacy module may be stored on the memory and configured to delete some or all of the patient medical information upon transmission with the communications network transceiver 270. In an example, the privacy module may be a sub-module of patient data module 287, or may be a separate, stand-alone module.

A settings module may be stored on the memory and configured to change (e.g., add, remove, rearrange or re-order) some or all of the plurality of medical care questions and/or medical care directions in response to user input regarding one or more configurations.

An update or “shopping” module may be stored on memory 220 and configured to invite a user to acquire one or more updates, e.g., language and/or question and/or directions supplements.

The device 210 may also include one or more sensors 250. Example sensor 250 include but are not limited to an accelerometer, a magnetometer, a pressure sensor, a temperature sensor, a gyroscopic sensor, a Global Positioning System (GPS) sensor, and a timer. Sensors 250 may be used to measure and collect data related to surroundings of the user. Additionally, outputs generated by sensors 250 may, for example, be indicative of movements of the user as a function of time.

Medical translator 280 may be interfaced with sensors 250. When executed on processor 260, medical translator 280 is configured to resolve and integrate the outputs generated by sensors 250 into useful information about at least one of: one or more movements of a patient user, one or more spatial positions of the patient user, associated time-stamps and one or more images of the patient user.

During operation (e.g., when executed by processor 260), medical translator 280 may store user-related information in patient data module 287. The user-related information of a particular patient may, for example, include one or more of: patient name, patient gender, patient symptoms, patient signs, patient medical history, and a patient image.

Network interface 270 may enable the client device 210 to upload the patient-related information to server and/or directly to a medical provider device. For example, patient information may be transmitted by email in a comma separated variable format. Additionally, network interface 270 may enable client device 210 to access server 110 to update a medical translator software product and/or download one or more new software products associated with a medical translator and medical care facilitation. Network interface 270 may also enable client device 210 to communicate with other client devices, for example, via communication network 130.

The operations may be implemented at least in part using an end-user interface (e.g., web-based interface). In an example, the end-user is able to make predetermined selections, and the operations described above are implemented on a back-end device to present results to a user. The user can then make further selections. It is also noted that various of the operations described herein may be automated or partially automated.

In an example, the medical translator has three primary menus, accessed from a home page. FIG. 3 is an example patient interface 300 of the medical translator. An example home page display of the patient interface 300 is shown as it may be presented to I/O devices 240 of client device or system 210. Frame 310 indicates which page of an interactive path is being presented to the patient. “Options” tab 320 may be selected by a user to present various controls for changing settings of the medical translator. For example, a user may enter or change email addresses that receive patient information gathered by medical translator 280. Changing settings of the medical translator is described below with reference to FIGS. 7-9. “Feedback” tab 330 enables a user to submit feedback regarding the medical translator. Additional information or operations may be accessed by a user through selection of a “more” tab 340.

A patient or other user (e.g., relative or other person accompanying the patient) may select a “check in” button 350 to initiate a series of questions and prompts of a “check in” path, may select “triage” button 360 to initiate a series of questions and prompts of a “triage” path, or may select “actions” button 370 to initiate a series of prompts of an “actions” path as described in greater detail with reference to FIG. 4 below.

Language indicator 380 presents the currently selected language. A user may switch between languages by, for example, touching language indicator 380.

In an example, the user may use “image” button 390, the user may capture an image of the patient, e.g., for association (e.g., in patient data module 287) with answers or responses during one or more of the “check in”, “triage” and “actions” paths. Image capture may employ one or more of sensors 250 of client device 210, such as, for example, a camera.

FIG. 4 is a flowchart illustrating example operations which may be implemented by the medical translator. In accordance with a computer-implemented method of facilitating medical care a plurality of selectable language options are offered in step S410 and a language option selection is received in step S420. In an example, the plurality of selectable language options may be output to the client device(s) and the patient selection of language option may be received by one or more of the client devices.

A plurality of selectable interactive paths are presented in step S430, e.g., in accordance with the language option selection received in step S420. Example selectable interactive paths may include but are not limited to a “check-in” path, a “triage” path, and/or an “action” path. In an example, the plurality of selectable interactive paths may be presented from a server to each of a plurality of client devices.

A user may select an interactive path. Or an interactive path may be selected for the user based on user input. In another example, the interactive path may be selected at least partly by the user and partly automatically. In any case, the choice of interactive path is accepted in step S440 and, in accordance with the language option selection and the choice of interactive path, a plurality of medical care questions or directions are output to the user according to a step S450. For example, client device 210 and medical translator 280 may output a series of medical questions to a patient in the form of one or more interfaces of a “check in” path. Or for example, client device 210 may output a series of questions to an EMT (or other care provider) in the form of one or more interfaces of a “triage” path. Or for example, client device 210 may output a series of directions to a patient and/or EMT (or other care provider) in the form of one or more interfaces of an “actions” path.

Any suitable questions, directions, and/or other information may be output. It is noted that the medical translator is not limited to any particular type or ordering of questions, directions, and/or other information. The questions, directions, and/or other information may depend at least in part on design considerations, such as end-user (e.g., patient or EMT).

For purposes of illustration, a “check-in” path may assist a patient who enters the lobby of a health care facility so that the facility is able to collect basic information from the patient. A “triage” interactive path is arranged for an emergency situation. For example, the Triage interactive path can be used in an ambulance, in the field, or at a hospital. An “Actions” interactive path assists a nurse or other assistant with providing instruction to a patient without necessarily collecting patient information.

In an example where the medical translator is an appliance (as opposed to a stand-alone device), a patient's choice of interactive path may be accepted by a server in response to patient input at a client device and the plurality of medical care questions or directions may be output by the server to the client device of the patient.

It is noted that the medical translator may also include input and/or output of various media (e.g., photos, graphics, video, audio). The media associated with the plurality of medical care questions or directions may be output by medical translator 280 as the user proceeds through a chosen interactive path. Such media may be presented in the language option selected by the user.

In step S460, when a patient user responds to the questions or directions, the medical translator receives patient medical information input from a patient user proceeding along a “check-in” path and receives patient emergency medical information input from a patient user proceeding along a “triage” path. Such patient medical information and emergency medical information may be stored, permanently or temporarily by patient data module 287. As discussed with reference to FIG. 3, image data of the patient may be captured and associated with the patient medical information by use of image button 390 and sensors 250.

In step S470, received patient medical information or patient emergency medical information is transmitted (e.g., over a communications network) to a location accessible to facility care providers tasked to address medical needs of the patient. For example, the medical information may be transmitted from an EMT to an emergency room, from a patient check-in area to an admissions department (and even to administration offices such as billing). It is noted that the patient medical information may be transmitted by any of a variety of means including but not limited to electronic mail; and may be packaged in any of a variety of configurations including but not limited to comma separated variable format. To help protect confidentiality, patient information may be deleted in whole or part (e.g., only personally identifiable information) in step S480.

The operations shown and described herein are provided to illustrate example implementations. It is noted that the operations are not limited to the ordering shown. Still other operations may also be implemented.

FIG. 5 shows an interface of the medical translator illustrating an example “check in” interactive path 500. In the example interface shown in FIG. 5, a heading 510 indicates to the user a question being presented. By way of illustration, a question is shown from the “check in” path and represents the eighth question of ten total questions.

A user may return to the main menu by engaging main menu button 520. Pane 530 is configured to display or otherwise present output media associated with the question indicated at heading 510 and controls 535 enable a patient user to stop, play, fast forward or rewind a media presentation.

It should be noted, however, that controls 535 may enable additional control such as to adjust volume, presentation speed, etc. Through use of back button 540 a patient may return to a preceding question and through use of skip button 550, the patient may advance to the following question within the chosen interactive path.

Line 560 presents text of the question indicated in heading 510 and interface 570 presents, for example, response selections corresponding with question text 560. To submit patient responses to the question indicated at heading 510 and advance to a following question the patient engages submit button 580.

It is noted that the “triage” interface (not shown separately) may be configured similarly to interface 500, but include questions, directions and/or other information formulated to address emergency medical care (e.g., for an EMT or other first responder).

FIG. 6 shows an interface of the medical translator illustrating an example “action” interactive path. Heading 610 indicates the direction being presented is from an action path and may represent any of a number of total directions or other information. A user may return to the main menu by engaging main menu button 620.

Pane 630 is configured to display or otherwise present output media associated with the direction indicated at heading 610. The interface may also include controls 635 that enable a user to stop, play, fast forward or rewind a media presentation. It should be noted, however, that controls 635 may enable additional control such as to adjust volume, presentation speed, etc. Line 640 presents text of the direction indicated in heading 610.

FIG. 7 is another flowchart illustrating example operations which may be implemented by the medical translator. In accordance with a computer-implemented method for reconfiguration, user input regarding one or more configurations is received in a step S710 and the plurality of medical care questions or directions of an interactive path are reconfigured in a step S720 in response to the user input. Reconfiguration may include, for example, eliminating one or more questions or directions or changing question or direction order.

In an example, reconfiguring the plurality of medical care questions or directions may include issuing commands to change question and/or direction order at a central configurations repository such as 140. User input to remove (add and/or re-order) one or more questions or directions, or to change a question or direction order is received and, subsequently, corresponding changes in configuration are presented to one or more patients at each of a plurality of client devices. Thus, manual reconfiguration at each of the client devices is not necessary.

In a step S730, the user may be invited to acquire one or more updates or module supplements (e.g., in return for payment). By way of example, after the user selects and installs a language update, the user may be offered one or more additional selectable language options in a step S740. Operations of the medical translator may then proceed similarly to the method described with reference to FIG. 4.

Medical translator 280 receives the patient language selection in a step S750, and a plurality of selectable interactive paths are presented in step S760 in accordance with the language option selection. After a user selects one of the plurality of interactive paths, the choice of interactive path is accepted in step S770 and, in a step S780, a plurality of medical care questions or directions are output to the user in accordance with the language option selection and the choice of interactive path.

FIG. 8 shows an interface of the medical translator illustrating an example question reconfiguration interface. In this example, interface 800 is arranged to reconfigure an interactive path. For example, heading 810 may indicate a “check in” path is being reconfigured. A position column 820 of interface 800 includes a plurality of entries 870 each reflecting the ordinal position of a question or direction from the interactive path.

A question or direction ID column 830 includes a plurality of entries each reflecting a numerical identifier of a question or direction. A question or direction text column 840 is shown as it may include a plurality of entries representing the text of a question or direction associated with an ordinal position and an ID. Edit buttons 850 enable a user to edit a question text, position or ID while delete buttons 860 allow a user to eliminate a question from the interactive path.

It is noted that the interface 800 is shown in FIG. 8 for purposes of example. Other reconfiguration interfaces may also be provided for other interactive paths that are available for selection. For example, there may be a reconfiguration interface for a “triage” interactive path, a “check-in” interactive path as well as for an “actions” interactive path. Still other interactive paths, and hence reconfiguration interfaces, are also contemplated.

FIG. 9 is shows an interface of the medical translator illustrating an example of language acquisition. Interface 900 is shown as it may include a heading 910 indicating that interface 900 is a language acquisition interface. A language name column 920 includes a number of entries 970 reflecting names of languages loaded on language translator 280, client devices 210 and/or server 110.

In this example, a price column 930 is shown as it may include a plurality of entries each associated with a language name of column 920 and reflecting the cost of the language module. Edit buttons 940 and delete buttons 950 enable a user to respectively edit or delete language modules from the language translator. Deleted languages will not be selectable by a patient user operating medical translator 280. Selection of button 960 allows a user to choose, for configuration with language translator 280, one or more additional language modules available for implementation.

It is noted that the examples shown and described are provided for purposes of illustration and are not intended to be limiting. Still other examples are also contemplated.

1. A medical translator computer program product including computer-readable instructions stored on non-transient computer-readable media and executable by a processor to:
receive a language option selected from a plurality of selectable language options;
receive a interactive path selected from a plurality of selectable interactive paths; and
output a plurality of medical care questions in the language option selection and in accordance with the selected interactive path.

2. The medical translator computer program product of claim 1, wherein the computer-readable instructions are executable to receive patient medical information in accordance with a “check-in” interactive path.

3. The medical translator computer program product of claim 1, wherein the computer-readable instructions are executable to receive patient emergency medical information in accordance with a “triage” interactive path.

4. The medical translator computer program product of claim 1, wherein the computer-readable instructions are executable to output a medical direction in accordance with an “action” interactive path.

5. The medical translator computer program product of claim 1, wherein the computer-readable instructions are executable to receive patient medical information in accordance with the selected interactive path.

6. The medical translator computer program product of claim 5, wherein the computer-readable instructions are executable to transmit the patient medical information to a medical provider.

7. The medical translator computer program product of claim 1, wherein the computer-readable instructions are executable to reconfigure the plurality of medical care questions in response to user input regarding one or more configurations.

8. The medical translator computer program product of claim 1, wherein the computer-readable instructions are executable to reconfigure the plurality of medical care questions to eliminate one or more questions from an offering of medical care questions presented to a user.

9. The medical translator computer program product of claim 1, wherein the computer-readable instructions are executable to reconfigure the plurality of medical care questions to change order of questions presented to a user.

10. The medical translator computer program product of claim 1, wherein the computer-readable instructions are executable to output visual and/or audible media associated with the plurality of medical care questions.

11. A method of medical translation by executing computer-readable instructions stored on non-transient computer-readable media and executable by a processor to:
receive a language option selection by a patient from a plurality of selectable language options;
receive a interactive path selected from a plurality of selectable interactive paths;
output at least one of medical care questions and medical care directions in the language option selection and in accordance with the selected interactive path; and
transmit patient medical information received from the patient over a communications network to a medical provider.

12. The method of claim 11, further comprising automatically removing identifiable patient medical information from a device receiving the patient medical information from the patient after receipt by the medical provider.

13. The method of claim 11, further comprising automatically removing all patient medical information from a device receiving the patient medical information from the patient after receipt by the medical provider.

14. The method of claim 11, further comprising reconfiguring the medical care questions and medical care directions at a central configurations repository to remove at least one of the medical care questions or medical care directions.

15. The method of claim 11, further comprising reconfiguring the medical care questions and medical care directions at a central configurations repository based on the selected interactive path.

16. A medical translator system, comprising:
a language selector configured to offer a plurality of selectable language options and receive a language option selection;
a path selector configured to offer a user a plurality of selectable interactive paths in accordance with the language option selection;
an interactive guide configured to render a plurality of medical care questions and/or medical care directions for the user in the language option selection and in accordance with the a selected interactive path; and
a patient data module configured to receive patient medical information from the user and transmit the patient medical information to a medical provider in accordance with the choice of interactive path.

17. The medical translator system of claim 16, wherein the plurality of interactive paths include at least one of a check-in path, a triage path and an action path.

18. The medical translator system of claim 16, further comprising an imaging component configured to capture image data and associate the image data with the patient medical information.

19. The medical translator system of claim 16, further comprising an update module configured to provide updates to at least one of the plurality of selectable language options, the plurality of medical care questions and/or medical care directions, and the plurality of selectable interactive paths.

20. The medical translator system of claim 19, a reconfiguration module to reconfigure the medical care questions and/or medical care directions based on the selected interactive path.
